(19) United States
(12) Patent Application Publication
(10) Pub. No.: US 2006/0106873 A1
(43) Pub. Date: May 18, 2006

(54) Selective clearing of persistent metadata in a storage subsystem

(75) Inventors: James A. Springer, Tucson, AZ (US); Yu-Cheng Hsu, Tucson, AZ (US); Lloyd P. Wiebe, Tucson, AZ (US); Kurt A. Lovrien, Tucson, AZ (US); David F. Mannenbach, Tucson, AZ (US); Angelique R. Budaya, Tucson, AZ (US)

Correspondence Address: LAW OFFICE OF DAN SHIFRIN, PC - IBM, 14081 WEST 59TH AVENUE, ARVADA, CO, 80004, US

(73) Assignee: International Business Machines (IBM) Corporation, Armonk, NY (US)

(21) Appl. No.: 10/993,092

(22) Filed: Nov. 18, 2004

(51) Int. Cl. G06F 17/00

(52) U.S. Cl. 707/104.1

(57) ABSTRACT

Method for selectively clearing persistent data such as metadata in a storage subsystem. The method includes identifying one or more metadata tracks to clear, receiving a request from a client to clear the identified metadata tracks, passing the request to a storage device driver, and clearing the identified metadata tracks. The metadata tracks to be cleared may be identified by a specific storage function associated with the metadata to be cleared or by a specific storage target associated with metadata. Alternatively, both a storage function and a storage target may be specified. Preferably, the request to clear one or more identified metadata tracks may be executed without affecting unrelated storage functions. In addition, the request may be executed while preserving metadata tracks unrelated to the identified metadata tracks. Thus, execution of a request to selectively clear identified global metadata tracks in accordance with the present invention will typically not cause the loss of configuration information and will not necessitate a reboot of the system. In addition, a request as described above may be executed at any point in time while the storage system is running.

### RELATED APPLICATION DATA

The present application is related to commonly assigned and copending U.S. application Ser. Nos. 10/______ [IBM Docket #TUC920040173], entitled MANAGEMENT OF METADATA IN A STORAGE SUBSYSTEM; 10/______ [IBM Docket #TUC920040174], entitled CLEARING METADATA TRACKS IN A STORAGE SYSTEM; 10/______ [IBM Docket #TUC920040175], entitled MANAGING ATOMIC UPDATES ON METADATA TRACKS IN A STORAGE SYSTEM, filed on the filing date hereof, which applications are incorporated herein by reference in their entirety.

### TECHNICAL FIELD

The present invention is related generally to enterprise storage subsystems, and in particular to selectively clearing persistent metadata in a storage subsystem.

### BACKGROUND ART

Enterprise computing systems typically include one or more host systems for processing customer data and running application programs, direct access storage devices (DASDs) for storing the data, and a one or more storage controllers for directing the storage and retrieval of data between the host(s) and the DASDs. In addition to the customer data, the storage controller typically maintains metadata which provides information about tracks or blocks of data in the DASD or in cache storage associated with the storage controller. The storage controller processes the metadata during certain operations on the customer data represented by the metadata to improve the speed and efficiency with which requested operations are performed. During DASD initialization, metadata is staged from disk to the cache. A power failure or certain other types of errors may cause the contents of the cache (a volatile type of storage) to be lost.

Certain storage controllers, such as the IBM™ Enterprise Storage Server™ (ESS), may be configured with copy services functionality, including (but not limited to) flash copy, peer-to-peer remote copy, extended remote copy, and concurrent copy which assist in backing up data and recovering from disasters. During a copy service (CS) operation, multi-field CS metadata is generated and maintained by the storage controller. The CS metadata includes information about the state of a copy services operation at any point in time, such as configuration information, internal settings, source and destination addresses, and other data about the state of data being copied. Consequently, if a controller loses power or encounters some other interrupting event, the controller may be restarted, the metadata read, the CS operation restored to the point of interruption and then resumed and completed.

Metadata may be either global or segmented. Global metadata is stored in reserved sections of the disk storage, independent of the associated customer data volumes; for security, three separate copies are kept. Segmented metadata is stored in a reserved section of a customer volume itself; only one copy is kept.

Since persistent data such as global and segmented metadata was maintained in several locations including on disk memory or specialized storage areas, and was associated with many possible functions and many possible logical or physical storage subsystems, selective clearing of metadata has been impractical. Prior systems included a mechanism known as clear status tracks (CST) to clear persistent data. Typical prior systems provided very little, if any, selectivity in the implementation of a CST command. In effect, the execution of a CST command would clear all persistent data such as metadata on a system.

Since customer storage tracks will typically be associated with metadata, execution of a CST could destroy customer data. In addition, in prior systems the execution of a CST could only occur during initial machine launch.

Thus, prior systems had no means for recovery from specific persistent data problems without clearing all persistent data, which could result in customer data loss. Consequently, it remains desirable for a method and apparatus to selectively clear specific metadata tracks while maintaining machine operability rather than clearing all metadata, possibly losing customer data, and rebooting the system.

### SUMMARY OF THE INVENTION

The present invention provides methods for selectively clearing persistent data such as global metadata (metadata) in storage subsystems. The method includes identifying one or more metadata tracks to clear, receiving a request from a client to clear the identified metadata tracks, passing the request to a storage device driver, and clearing the identified metadata tracks. The metadata tracks to be cleared may be identified by a specific storage function associated with the metadata to be cleared or by a specific storage target associated with metadata. Alternatively, both a storage function and a target may be specified. Representative storage functions having associated metadata include, but are not limited to, the copy functions of peer-to-peer remote copy (PPRC), extended distance remote copy (XRC), point-in-time copy, and other similar functions. Representative targets for a selective clear command include, but are not limited to, logical storage subsystems, logical volumes, physical storage volumes, or physical storage tracks.

The method may further include notifying one or more functional storage components that a request to clear the identified metadata tracks has been received and determining whether such a functional storage component must perform specific functions to execute the request. If no specific work is necessary to execute the request, a select functional storage component may simply return success to the storage controller. Alternatively, a functional storage component associated with the identified metadata tracks which are to be cleared may perform steps as are necessary to execute the request.

Preferably, the request to clear one or more identified metadata tracks may be executed without affecting unrelated storage functions. In addition, the request may be executed while preserving metadata tracks unrelated to the identified metadata tracks. A request as described above may be executed at any point in time while the storage system is running.

Although described above with respect to a method, the invention may also be implemented as a storage subsystem having apparatus capable of selectively clearing global metadata, an article of manufacture containing instructions for causing the selective clearing of global metadata, or a method of deploying computing infrastructure comprising integrating computer readable code with a storage subsystem such that the code in combination with the subsystem is capable of clearing global metadata.

### BRIEF DESCRIPTION OF THE DRAWINGS

FIG. 1 is a block diagram of a storage system in accordance with the present invention;

FIG. 2 is a flowchart illustrating the selective clearance of persistent metadata; and

FIG. 3 is a block diagram of a storage device driver having functional storage components in accordance with the present invention.

### DETAILED DESCRIPTION OF THE PREFERRED EMBODIMENT

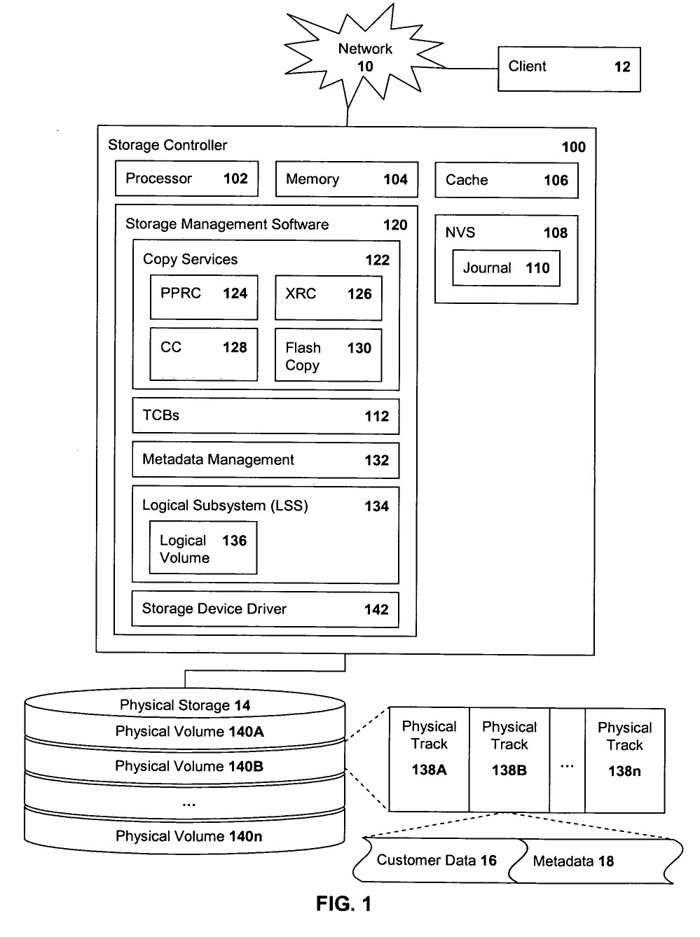

FIG. 1 is a block diagram of a storage controller 100 implementing the selective clearing of metadata of the present invention. The present invention may be used to clear both global and segmented metadata. The controller 100 is attached, through a network 10, to at least one client system 12. The controller 100 is also attached to at least one storage device 14, such as a direct access storage device (DASD).

The controller 100 includes a processor 102, general memory 104 for storing computer-readable code having instructions executable by the processor 102, a cache storage 106 and non-volatile storage (NVS) 108. The controller 100 further includes a journaling area 110 and storage management software 120, both of which may actually be stored in the memory 104. The storage management software 120 may include copy services (CS) code 122. The CS code 122 may include a peer to peer remote copy (PPRC) function 124, an extended distance remote copy (XRC) function 126, concurrent copy (CC) function 128, a flash copy or point-in-time copy function 130, or any combination of similar storage functions or services to assist in backing up data, copying data, and recovering from disasters.

The storage management software 120 further includes task control blocks 112, one or more logical subsystems (LSS) 134, configured into one or more logical volumes 136, and a storage device driver 142. In some storage controllers, both the cache 106 and the NVS 108 may be microcode constructs within the memory 104, configured by, and considered to be a part of, the device driver 142.

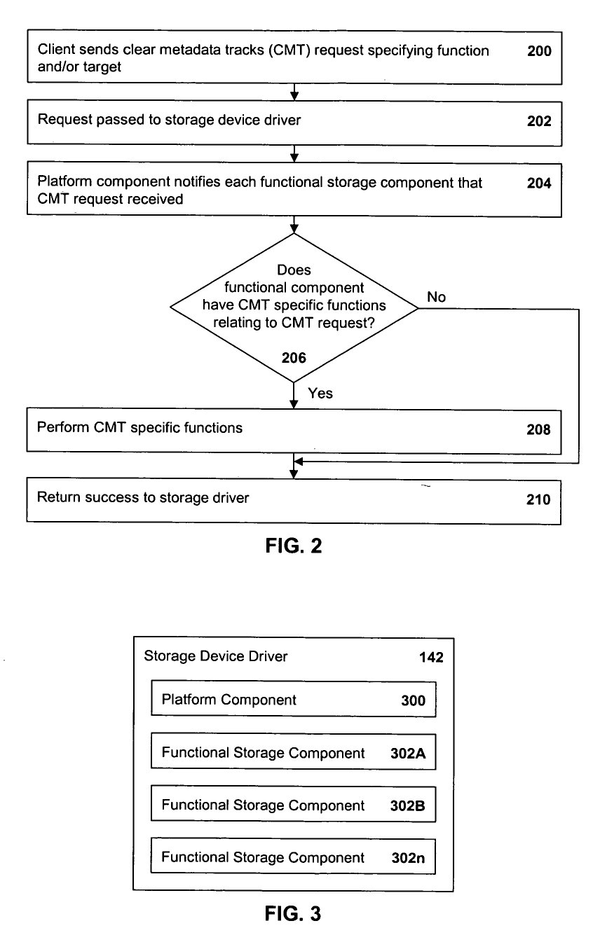

Referring to the flowchart of FIG. 2, the client 12 may send a clear metadata tracks (CMT) request to the storage controller 100. The CMT request may specify a function and/or a target (step 200). The specified function will typically be one of the many functions associated with copy services 122 such as PPRC copy function 124, XRC copy function 126, CC copy function 128, flash copy or point-in-time copy function 130, or other similar functions. The specified target may be a logical subsystem (LSS) 134, a logical volume 136, or specific physical storage tracks 138A, 138B . . . 138n associated with physical storage volumes 140A, 140B . . . 140n which are found on a physical DASD 14. Thus, the CMT request may identify a specific type of and location for the persistent global metadata which will be cleared.

After the CMT request is submitted by the client 12, it is passed to a device driver such as the storage device driver 142 (step 202). As shown in FIG. 3, the storage device driver 142 includes multiple software components. Included are a platform component 300 which provides low level services similar to those provided by a traditional operating system. Also included are multiple functional storage components 302A, 302B . . . 302n which perform specific functions related to storage device driver 142 operations such as copy service, cache and fixed-block.

Upon receipt at the storage device driver 142, the CMT request is processed by the platform component 300, which then notifies each functional storage component 302A, 302B . . . 302n that the CMT request has been received (step 204). If a specific functional storage component, 302A for example, has no relationship to the function or target specified in the CMT request, that functional component 302A will return successful processing of the CMT request to the storage device driver 142 without further operations (step 210). If, however, a specific functional component, 302B for example, does perform processing related to the function and target specified in the CMT request, that functional component 302B will cause the execution of commands and processes as necessary to selectively clear the global metadata tracks identified by the function and/or target specified in the CMT request (step 208). After the CMT request has been processed, the related functional storage component 302B can return success to the device driver 142 (step 210). To clear a metadata track, the component uses the parameters of the CMT request to identify the track(s) involved. A request is sent to the cache 106 to stage the track; the cache 106 notifies the component when the track is staged and provides a pointer to the track. The parameters are used to determine which section(s) of the track(s) to clear and the section(s) are cleared by zeroing. The cache 106 is notified that the track(s) may be destaged and the track(s) is(are) written to the disk storage 14.

Since the CMT request is processed in the limited and highly targeted fashion described above, unrelated metadata will not be affected and customer information will not typically be lost. Therefore, it is possible to execute the CMT command as described above while unrelated data processing and storage operations are ongoing, and without rebooting the system after the CMT request has been processed.

It is important to note that while the present invention has been described in the context of a fully functioning data processing system, those of ordinary skill in the art will appreciated that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for selectively clearing global metadata or a method for deploying computing infrastructure comprising integrating computer readable code into a computing system for selectively clearing global metadata.

What is claimed is:

1. A method of selectively clearing metadata in a storage subsystem comprising:
identifying one or more metadata tracks to clear;
receiving a request from a client to clear the one or more identified metadata tracks;
passing the request to a storage device driver; and
clearing the identified metadata tracks.

2. The method of claim 1 wherein identifying the metadata tracks to be cleared comprises specifying a storage function having associated metadata.

3. The method of claim 2 wherein the specified storage function is selected from a group consisting of copy functions, peer to peer remote copy functions, extended distance copy functions, point in time copy functions, and reset logical unit number functions.

4. The method of claim 1 wherein identifying the metadata tracks to be cleared comprises specifying a storage target associated with metadata.

5. The method of claim 4 wherein the specified storage target is selected from a group consisting of a logical subsystem, a logical volume, a physical storage volume, and a physical storage track.

6. The method of claim 1 further comprising notifying one or more functional storage components that a request to clear the one or more identified metadata tracks has been received.

7. The method of claim 6 further comprising determining if a select functional storage component must perform specific functions to execute the request to clear the one or more identified metadata tracks.

8. The method of claim 7 further comprising performing specific functions to execute the request to clear the one or more identified metadata tracks.

9. The method of claim 1 further comprising executing the request to clear the one or more identified metadata tracks without affecting unrelated storage functions.

10. The method of claim 1 further comprising preserving metadata tracks unrelated to the identified metadata tracks.

11. A storage subsystem comprising:
means for receiving a request from a client to clear one or more identified metadata tracks associated with the storage subsystem;
a storage device driver associated with the storage subsystem, the storage device driver comprising means for receiving the request to clear the one or more tracks of metadata; and
means for clearing the identified metadata tracks.

12. The storage subsystem of claim 11 wherein the metadata tracks to be cleared are identified by specifying a storage function having associated metadata.

13. The storage subsystem of claim 12 wherein the storage function specified to identify the metadata tracks to be cleared is selected from a group consisting of copy functions, peer to peer remote copy functions, extended distance copy functions, and point in time copy functions.

14. The storage subsystem of claim 11 wherein the metadata tracks to be cleared are identified by specifying a storage target associated with metadata.

15. The storage subsystem of claim 14 wherein the storage target specified to identify the metadata tracks to be cleared is selected from a group consisting of a logical subsystem, a logical volume, a physical storage volume, and a physical storage track.

16. The storage subsystem of claim 11 further comprising:
functional storage components associated with the storage device driver; and
means for notifying the functional storage components that a request to clear the one or more identified metadata tracks has been received.

17. The storage subsystem of claim 16 further comprising means for determining if a select functional storage component must perform specific functions to execute the request to clear the one or more identified metadata tracks.

18. The storage subsystem of claim 17 further comprising means for performing specific functions to execute the request to clear the one or more identified metadata tracks.

19. The storage subsystem of claim 11 wherein the means for clearing the identified metadata tracks does not affect unrelated storage functions.

20. The storage subsystem of claim 11 wherein the means for clearing the identified metadata tracks does not clear metadata tracks unrelated to the identified metadata tracks.

21. An article of manufacture for use in programming a data storage system to selectively clear metadata the article of manufacture comprising instructions for:
identifying one or more metadata tracks to clear;
receiving a request from a client to clear the one or more identified metadata tracks;
passing the request to a storage device driver; and
clearing the identified metadata tracks.

22. The article of manufacture of claim 21 wherein the instructions for identifying the metadata tracks to be cleared comprise instructions specifying a storage function having associated metadata.

23. The article of manufacture of claim 22 wherein the instructions specify a storage function selected from a group consisting of copy functions, peer to peer remote copy functions, extended distance copy functions, and point in time copy functions.

24. The article of manufacture of claim 21 wherein the instructions for identifying the metadata tracks to be cleared comprise instructions specifying a storage target associated with metadata.

25. The article of manufacture of claim 24 wherein the instructions specify a storage target selected from a group consisting of a logical subsystem, a logical volume, a physical storage volume, and a physical storage track.

26. The article of manufacture of claim 21 further comprising instructions for notifying one or more functional storage components that a request to clear the one or more identified metadata tracks has been received.

27. The article of manufacture of claim 26 further comprising instructions for determining if a select functional storage component must perform specific functions to execute the request to clear the one or more identified metadata tracks.

28. The article of manufacture of claim 27 further comprising instructions for performing specific functions to execute the request to clear the one or more identified metadata tracks.

29. The article of manufacture of claim 21 further comprising instructions for executing the request to clear the one or more identified metadata tracks without affecting unrelated storage functions.

30. The article of manufacture of claim 21 further comprising instructions for preserving metadata tracks unrelated to the identified metadata tracks.

31. A method for deploying a data storage infrastructure, comprising integrating computer readable code into a data storage system to selectively clear metadata in a storage subsystem wherein the code in combination with the data storage system is capable of performing the following:
identifying one or more metadata tracks to clear;
receiving a request from a client to clear the one or more identified metadata tracks;
passing the request to a storage device driver; and
clearing the identified metadata tracks.

32. The method for deploying a data storage infrastructure of claim 31 wherein the code in combination with the data storage system is further capable of identifying the metadata tracks to be cleared by specifying a storage function having associated metadata.

33. The method for deploying a data storage infrastructure of claim 32 wherein the storage function specified by the code in combination with the data storage system is selected from a group consisting of copy functions, peer to peer remote copy functions, extended distance copy functions, and point in time copy functions.

34. The method for deploying a data storage infrastructure of claim 31 wherein the code in combination with the data storage system is further capable of identifying the metadata tracks to be cleared by specifying a storage target associated with metadata.

35. The method for deploying a data storage infrastructure of claim 34 wherein the storage target specified by the code in combination with the data storage system is selected from a group consisting of a logical subsystem, a logical volume, a physical storage volume, and a physical storage track.

36. The method for deploying a data storage infrastructure of claim 31 wherein the code in combination with the data storage system is further capable of notifying one or more functional storage components that a request to clear the one or more identified metadata tracks has been received.

37. The method for deploying a data storage infrastructure of claim 36 wherein the code in combination with the data storage system is further capable of determining if a select functional storage component must perform specific functions to execute the request to clear the one or more identified metadata tracks.

38. The method for deploying a data storage infrastructure of claim 37 wherein the code in combination with the data storage system is further capable of performing specific functions to execute the request to clear the one or more identified metadata tracks.

39. The method for deploying a data storage infrastructure of claim 31 wherein the code in combination with the data storage system is further capable of executing the request to clear the one or more identified metadata tracks without affecting unrelated storage functions.

40. The method for deploying a data storage infrastructure of claim 31 wherein the code in combination with the data storage system is further capable of preserving metadata tracks unrelated to the identified metadata tracks.
